(19) United States
(12) Patent Application Publication
(10) Pub. No.: US 2002/0101406 A1
(43) Pub. Date: Aug. 1, 2002

(54) Touch-controlled hot key device

(76) Inventor: Chin-Shu Tseng, Taipei (TW)

Correspondence Address: BIRCH STEWART KOLASCH & BIRCH, PO BOX 747, FALLS CHURCH, VA, 22040-0747, US

(21) Appl. No.: 09/769,447

(22) Filed: Jan. 26, 2001

(51) Int. Cl. G09G 5/00

(52) U.S. Cl. 345/173

(57) ABSTRACT

In a hot key device, users can designate the functions and icons of a plurality of touch-controlled hot keys. The device is connected through a bus to the host computer for receiving signals of hot key settings of the user. The signals are processed by a processor for displaying icons on a touch screen panel. The device makes the user-defined hot key settings possible that the user can recognize his or her specified hot key icons shown on the screen and activate them simply by touch.

### BACKGROUND OF THE INVENTION

1. Field of Invention

The present invention generally relates to a hot key device applicable to computers, such as personal computers or notebook computers, and more particularly relates to a hot key device that the functions and icons of hot keys can be designated by user.

2. Related Art

“Hot key” means a combination of some specific keys used on computer for an application software to execute a certain function. By which, the specific function can be simply and quickly activated without the need of keying a command. Some stay resident programs are also activated by hot keys. There are two categories of stay resident program. One of which are programs executed timely or activated by other programs, for example, language systems, clock or font diver programs; The other category are programs, such as for image fetching or personal tools, which can be designated by a combination of keys, and, that are hot keys.

Most of the current computers, especially notebook computers, are equipped with some programmable keys. Similar to hot keys, the programmable keys can be used to execute specific programs or functions. These programmable keys are generally located on the keyboard. Common programmable keys are “Internet key” for linking to the web, “Email key” for sending and receiving emails, and so on.

Though the hot keys or programmable keys are convenient, the icons printed on the keys are fixed that cannot be easily recognized of their meanings by the user. Sometimes, there are even no icons printed. Therefore, it is difficult for users to identify the functions of the hot keys.

### SUMMARY OF THE INVENTION

It is therefore an object of the present invention to provide a hot key device in which the functions and icons of hot keys can be designated by users.

Another object of the present invention is to provide a hot key device in which the hot keys can be controlled through a touch screen panel.

According to the present invention, the functions and icons of a plurality of touch-controlled hot keys can be designated by users. The device is connected through a bus to the host computer for receiving signals of hot key settings of the user. The signals are processed by a processor for displaying icons on a touch screen panel. The device makes the user-defined hot key settings possible that the user can recognize his or her specified hot key icons shown on the screen and activate them simply by touch.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow illustration only, and thus are not limitative of the present invention, and wherein:

FIG. 1 is a block diagram of the present invention showing the composition of a hot key device.

### DETAILED DESCRIPTION OF THE INVENTION

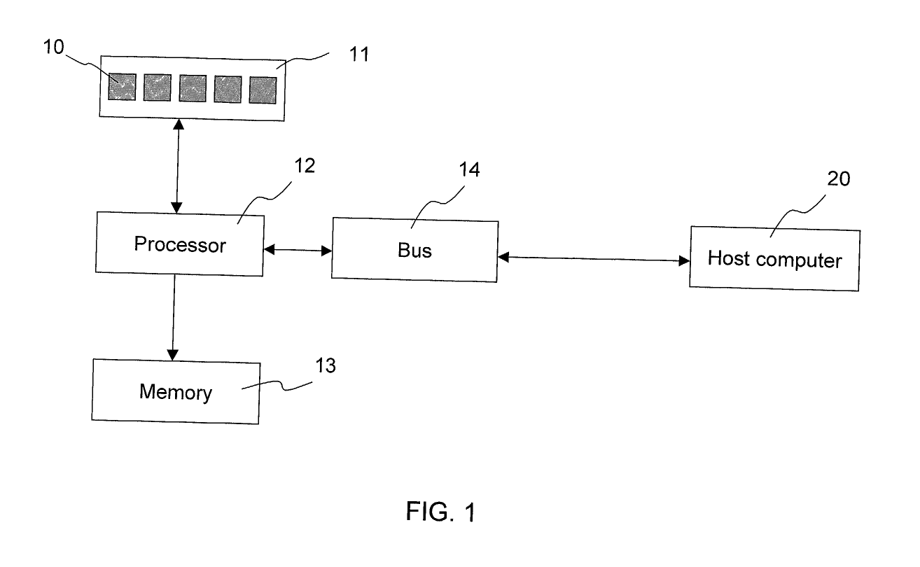

As shown in FIG. 1, a touch-controlled hot key device according to the present invention includes a bus 14 for transferring hot key setting signals from a host computer 20 to a processor 12. The processor 12 processes the signals and generates corresponding hot key icons 10 on a touch screen panel 11. A memory unit 13 is used to store the hot key settings. When user touching an icon 10 on the screen panel 11, the processor 12 transfers hot key command through the bus 14 to the host computer 20. So that, the host computer 20 can execute the hot key command.

The size of the touch screen panel 11 can be determined by the maximum number of icons. Generally, five icons are enough for common use, as shown in the drawing, so a small size screen panel can be applied. But, of course, the icons are not limited to five ones. The bus 14 can be an 12C (inter-integrated circuit), a PS/2 bus, a USB (universal serial bus) or others. And, the host computer 20 can be a personal computer, a notebook computer or others.

By the aforesaid composition, the functions and icons of hot keys can be defined by user. The user's settings are initiated through the host computer 20, transferred via the bus 14, processed by the processor 12, stored into the memory unit 13, and displayed with icons 10 on the touch screen panel 11. During using, the user touching a specific icon 10 on the touch screen panel 11 will generate a hot key command through the processor 12 and the memory unit 13, and pass the command via the bus 14 to the host computer 20. Since the hot keys are defined by the user, the user can easily recognize the icons 10 shown on the touch screen panel 11 without the need of hard memorization for the meanings of icons.

The memory unit 13 is used for storing the functions and icons 10 of hot keys. So that, after restarting the host computer 20, the hot key information can be retrieved from the memory unit 13 by the processor 12, and displayed with corresponding icons 10 on the touch screen panel 11. The memory unit 13 can be a flash ROM or the like. If the hot key settings are refreshed by user, the new settings will be updated into the memory unit 13, therefore, the new icons 10 will be correctly displayed in next starting, and corresponding functions can be activated by touching the icons 10.

The hot key device can be made as a unit separated from the host computer 20, or incorporated into the keyboard or other portion of the host computer 20. In a keyboard, for example, at least a touch screen panel 11, a processor 12, and a memory unit 13 is mounted for user to define the hot key functions and icons 10. After the setting, when user touching an hot key icon 10 on the touch screen panel 11, the processor 12 will transfer the hot key command through the bus 14 of the keyboard to the host computer 20 and execute the hot key command. Since the hot key icons are defined by the user, he or she can easily identify them without the need of hard memorization.

In conclusion, the user can customize the touch-controlled hot key device easily with its icons and relative functions. So that, the user can recognize the meanings of the icons directly without any difficulty of learning or memorizing.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A touch-controlled hot key device, connected to a host computer, capable of being defined by user with hot key icons and relative functions, comprising:
a bus, for transferring hot key information between from said host computer;
a processor, for receiving and processing said hot key information to generate corresponding hot key icons; and
a touch screen panel, for showing said hot key icons, and receiving user's touch to generate corresponding command;
whereby, when an hot key icon shown on said touch screen panel being touched, said corresponding command is processed by said processor, transferred via said bus to said host computer, and executed by said host computer.

2. A touch-controlled hot key device according to claim 1 in which said bus is an inter-integrated circuit.

3. A touch-controlled hot key device according to claim 1 in which said bus is a PS/2 bus.

4. A touch-controlled hot key device according to claim 1 in which said bus is a universal serial bus.

5. A touch-controlled hot key device according to claim 1 in which said hot key is an Internet key.

6. A touch-controlled hot key device according to claim 1 in which said hot key is an email key.

7. A touch-controlled hot key device according to claim 1 further comprises a memory unit for storing said hot key information.

8. A touch-controlled hot key device according to claim 7 in which said memory unit is a flash ROM.

9. A touch-controlled hot key device according to claim 7 in which said memory unit stores information of hot key icons and corresponding functions that users update.

10. A touch-controlled hot key device, incorporated with keyboard of a host computer, capable of being defined by user with hot key icons and relative functions, comprising:
a bus, substantially the bus of said keyboard, for transferring hot key information from said host computer;
a processor, for receiving and processing said hot key information to generate corresponding hot key icons; and
a touch screen panel, mounted on said keyboard, for showing said hot key icons, and receiving user's touch to generate corresponding command;
whereby, when an hot key icon shown on said touch screen panel being touched, said corresponding command is processed by said processor, transferred via said bus to said host computer, and executed by said host computer.

11. A touch-controlled hot key device according to claim 10 in which said bus is an inter-integrated circuit.

12. A touch-controlled hot key device according to claim 10 in which said bus is a PS/2 bus.

13. A touch-controlled hot key device according to claim 10 in which said bus is a universal serial bus.

14. A touch-controlled hot key device according to claim 10 in which said hot key is an Internet key.

15. A touch-controlled hot key device according to claim 10 in which said hot key is an email key.

16. A touch-controlled hot key device according to claim 10 further comprises a memory unit for storing said hot key information.

17. A touch-controlled hot key device according to claim 16 in which said memory unit is a flash ROM.

18. A touch-controlled hot key device according to claim 16 in which said memory unit stores information of hot key icons and corresponding functions that users update.
